(19) United States
(12) Patent Application Publication
(10) Pub. No.: US 2008/0302481 A1
(43) Pub. Date: Dec. 11, 2008

(54) METHOD AND APPARATUS FOR DEBONDING OF STRUCTURES WHICH ARE BONDED TOGETHER, INCLUDING (BUT NOT LIMITED TO) DEBONDING OF SEMICONDUCTOR WAFERS FROM CARRIERS WHEN THE BONDING IS EFFECTED BY DOUBLE-SIDED ADHESIVE TAPE

(75) Inventors: Alexander J. Berger, Palo Alto, CA (US); Michael A. Berger, Palo Alto, CA (US)

Correspondence Address: MACPHERSON KWOK CHEN & HEID LLP, 2033 GATEWAY PLACE, SUITE 400, SAN JOSE, CA, 95110, US

(73) Assignee: Tru-Si Technologies, Inc.

(21) Appl. No.: 11/759,682

(22) Filed: Jun. 7, 2007

(51) Int. Cl. B32B 38/10

(52) U.S. Cl. 156/344; 156/584

(57) ABSTRACT

When heat or UV radiation is applied to an adhesive tape (130) which bonds a semiconductor wafer (110) to a carrier (120), the appropriate lift-off time for separating the wafer from the carrier is determined by monitoring the thickness (T or ΔT) of the wafer/tape/carrier sandwich. When the thickness or the thickness change has reached a predefined value or range of values, independently moveable driving members (510R) drive the wafer or the carrier with small forces at a plurality of spaced-apart locations along the periphery. As a result, the lift-off is initiated at the location of the weakest adhesion.

### BACKGROUND OF THE INVENTION

The present invention relates to debonding of adhesively-bonded structures. Some embodiments involve debonding semiconductor wafers from carriers in fabrication of semiconductor integrated circuits.

When a semiconductor wafer 110 (FIG. 1) is subjected to etching, depositions, photolithography, grinding, and other processes, the wafer can be bonded to a carrier 120 to strengthen the wafer against mechanical stresses and flatten the wafer if the wafer is warped. This is particularly desirable for thin, fragile wafers. A wafer can be initially thick but then thinned down while bonded to the carrier. The bonding can be performed with a double-sided adhesive tape 130. When the wafer has been processed as desired, the carrier must be debonded. Heat or UV radiation can be applied, depending on the type of tape 130, to cause gas emission from the adhesive on at least one side of tape 130 (top side in FIG. 2). The gas weakens the adhesive bond, and the carrier can be detached (“lifted off”). For example, a vacuum chuck (not shown) may pull the carrier upward away from the wafer. In a “wedge-lift-off” process, the carrier is first detached on one side (the right side in FIG. 3). Air enters between the wafer and the carrier on that side, facilitating complete carrier separation from the wafer.

### SUMMARY

This section summarizes some features of the invention. Other features are described in the subsequent sections. The invention is defined by the appended claims which are incorporated into this section by reference.

The lift-off process illustrated in FIG. 3 should begin at an optimal time when the gas emission from tape 130 has weakened the bond to a suitable level. If the lift-off is attempted too early, when the bond is still strong, the lift-off may be unsuccessful and may damage the wafer or the carrier. On the other hand, if the lift-off is delayed, the gas may escape to allow re-adhesion of the carrier to the wafer.

Careful timing of the lift-off process is complicated because the appropriate lift-off time depends on the materials present in the wafer (as they may affect thermal conductivity), the wafer thickness, and possibly other conditions which may vary from wafer to wafer.

Some embodiments of the present invention monitor the thickness T (FIG. 4) of the carrier/tape/wafer sandwich. The gas emission from tape 130 increases the thickness T, and the thickness increase ΔT may be a good indicator as to when the lift-off should start.

In addition, the inventors have observed that the gas emission from the tape may be non-uniform across the tape 130, resulting in non-uniform weakening of the adhesive bond. The lift-off should preferably start at a location at which the bond is weaker. In some embodiments, the lift-off is simultaneously attempted at different locations around the periphery, using independently moveable driving members at the different locations. The wafer/carrier separation occurs first at the location of the weakest bond. Air enters between the carrier and the wafer at that location, facilitating further separation of the wafer from the carrier.

Other features are described below. The invention is defined by the appended claims.

### BRIEF DESCRIPTION OF THE DRAWINGS

FIGS. 1-3 are side views of a wafer/tape/carrier system in a prior art debonding process.

FIGS. 4, 5A are side views of a debonding system according to some embodiments of the present invention.

FIG. 5B is a top view of the debonding system of FIG. 5A.

FIG. 6 is a side views of the debonding system of FIG. 5A at an intermediate stage in a debonding process according to some embodiments of the present invention.

FIG. 7 is a flowchart of a debonding operation according to some embodiments of the present invention.

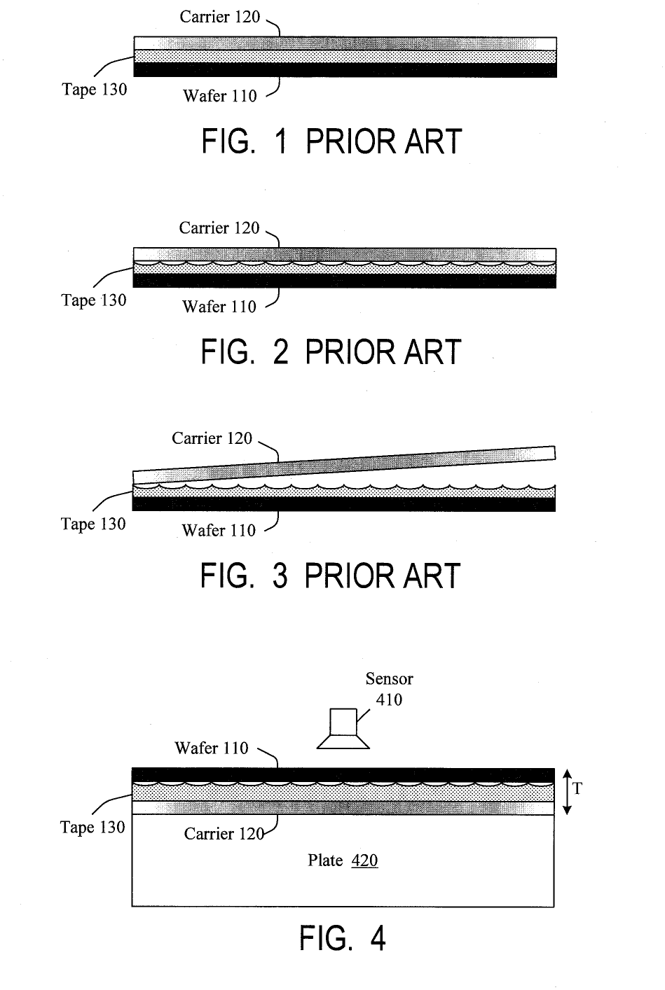

### DESCRIPTION OF SOME EMBODIMENTS

The embodiments described in this section illustrate but do not limit the invention. The invention is defined by the appended claims.

FIG. 4 illustrates a sensor 410 monitoring the thickness T of the structure consisting of semiconductor wafer 110 (e.g. a silicon wafer), carrier 120 (e.g. glass or silicon), and double-sided adhesive tape 130 bonding the wafer to the carrier. In FIG. 4, the gas emission from tape 130 occurs on the carrier side, but in other embodiments the gas emission may occur on the wafer side or on both sides. Wafer 110 can be a thick wafer, or can be a thin wafer tending to warp if left loose. The wafer rests on a plate 420, or is supported by a suitable chuck (e.g. a vacuum or electrostatic chuck, not shown), possibly by an end effector. The sensor can be a laser displacement sensor merely indicating the displacement of the top surface of carrier 120, or some other type of sensor. When the sensor's data indicate that the thickness T increases to a predefined value T₁, or the thickness falls in a predefined range, or the thickness increase ΔT reaches a predefined value ΔT, or falls in a predefined range, the lift-off is initiated. Suitable values for T, or ΔT, or suitable ranges may depend on the type of the adhesive, and can be determined experimentally. In some embodiments, for example, the lift-off starts when ΔT is in the range of 150 to 190 μm.

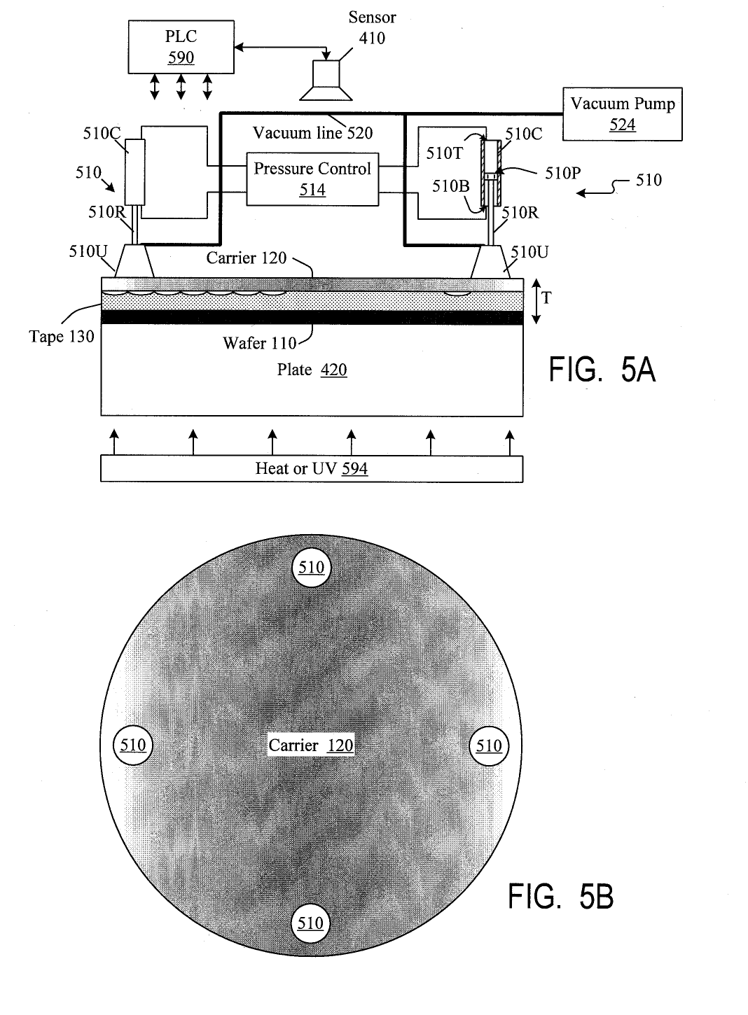

FIGS. 5A, 5B illustrate respectively side and top views of some features of the debonding system according to some embodiments of the invention. The lift-off is accomplished with four identical vacuum pickers 510 which pull on carrier 120 at respective four equidistant locations along the carrier's periphery (the locations are “equidistant” in the sense that each location is about equidistant from its two adjacent locations along the periphery). Each vacuum picker includes a stationary hollow cylinder 510C. A reciprocating plunger 510P moves up and down inside the cylinder independently of the other plungers 510P. In some embodiments, very small friction (almost zero) is achieved between the plunger and the cylinder. The small friction can be achieved by a suitable choice of materials, e.g. glass for the cylinder and steel for the plunger. Port 510T is provided at the top of the cylinder to receive air pressure from pressure control system 514 to push the plunger down. Port 510B is provided at the bottom of the cylinder to receive air pressure from system 514 to push the plunger up. The small friction enables the plungers 510P to move in response to a very small force. Each plunger 510P is attached to one end of a rigid rod 510R whose other end is attached to a hollow suction cup 510U having a flexible rim for vacuum attachment to carrier 120. A vacuum line 520 shared by the four vacuum pickers 510 receives vacuum from a vacuum pump 524. Vacuum line 520 branches into four lines, each line providing a vacuum passage to the respective hollow suction cup 510U.

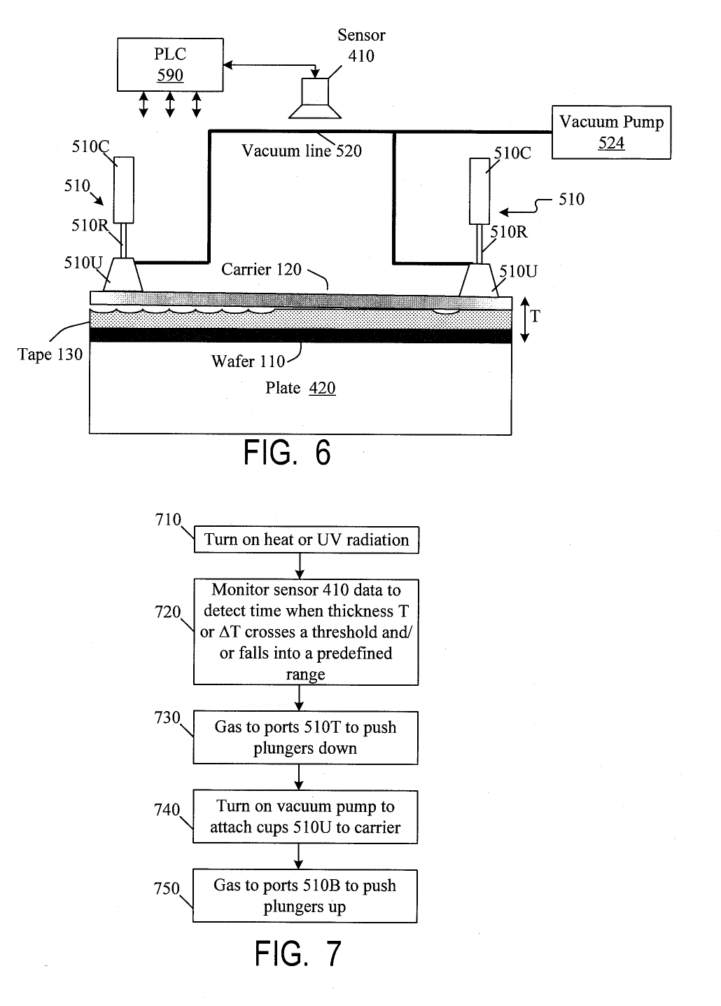

The debonding operation is performed as shown in FIG. 7, possibly under control of a controller 590 (e.g. a programmable logic controller (PLC)). At step 710, the controller turns on a heat and/or UV source 594 to apply heat and/or UV radiation to tape 130 (e.g. from above carrier 120 as in FIG. 5A, or from below wafer 110). Controller 590 monitors data from sensor 410 to determine whether or not the thickness T or the thickness change ΔT has reached the predefined threshold or range (step 720). When controller 590 determines that the predefined threshold or range has been reached (possibly filtering out noise to disregard unreliable data values from sensor 410), controller 590 causes system 514 to supply gas (e.g. air) to ports 510T of cylinders 510C to push the plungers 510P down (step 730). As a result, suction cups 510U come in contact with carrier 120. Vacuum pump 524 is then turned on by controller 590 to supply vacuum to cups 510U (step 740). The cups' flexible rims become attached to carrier 120 by suction. Then controller 590 causes system 514 to supply gas to the bottom ports 510B of cylinders 510C to push the plungers 510R upward (step 750). In some embodiments, the upward force acting on the plungers is slightly greater than the weight of carrier 120, plungers 510P, rods 510R and cups 510U so that the carrier would not start to lift off at any location at which the adhesive bond is still strong. For example, the upward force can be 30 g (7.5 g per vacuum picker) for a 20 g carrier. The appropriate force can be determined experimentally for a given type of carrier and adhesive. (In some embodiments, the carrier is a glass or semiconductor wafer, but these embodiments are not limiting.) The carrier begins to lift off at the location of the weakest bond, which could be on the left side in FIG. 5A since the strongest gas emission occurs on the left side in this example. Rods 510R are moveable independently from each other as shown in FIG. 6, to allow the rod 510R on the left side to move up by a greater distance in impelling motion to the carrier than the rod on the right side.

The invention is not limited to the embodiments described above. For example, a separate vacuum pump 524 can be used for each vacuum picker. Any number of vacuum pickers can be used. In some embodiments, the vacuum pickers attach to wafer 110 rather than the carrier. For example, the wafer 110 could be on top in the system of FIGS. 5A, 5B. Wafer 110 can be replaced with a stack of wafers, dies, or other substrates bonded together. Carrier 120 can also be replaced with a stack of substrates. The vacuum pickers can be replaced with other types (e.g. non-vacuum types) of lift-off devices.

Some embodiments include a method for debonding a first structure (e.g. 110 or 120) from a second structure (e.g. 120 or 110) which is bonded to the first structure with a bonding layer (e.g. 130) comprising an adhesive, the method comprising: (1) causing the adhesive to emit gas which weakens a bond between the first and second structures; and (2) applying a force to separate the first and second structures from each other when the bond is weakened; wherein operation (1) comprises monitoring a thickness characteristic (e.g. T or ΔT or some other parameter related to the thickness) of a system comprising at least a portion of the adhesive (e.g. the thickness of tape 130, or of a system consisting of tape 130 and one or both of wafer 110 and carrier 120), and operation (2) is started in response to the thickness characteristic crossing a predefined threshold and/or being in a predefined range.

In some embodiments, operation (2) comprises driving the first structure with a plurality of driving members each of which is coupled to the first structure at a periphery of the first structure and/or at a periphery of the bonding layer. Each driving member may consist of a rod 510R for example, or of the combination of rod 510R and suction cup 510U coupling the rod to the carrier, or of the combination of rod 510R, suction cup 510U, and the respective plunger 510P.

In some embodiments, the driving members are moveable independently from each other in impelling motion to the first structure. For example, rods 510R are moveable up and down independently from each other. Even if pressure control system 514 cannot supply pressure selectively to each port 510B and/or 510T, i.e. even if control system 514 can only supply equal pressure to ports 510B or to ports 510T, the rods 510R can still move independently if different external forces are applied to the rods, as for example at the stage of FIG. 6. (The invention is not limited to control system 514 being unable to supply different pressures to different vacuum pickers 510 at the same time.)

In some embodiments, in operation (2) the driving members are driven with identical forces at least before the first structure separates from the second structure in at least one area.

Some embodiments include a method for debonding a first structure from a second structure, one of the first and second structures comprising a semiconductor wafer, the method comprising: (1) providing a plurality of driving members (e.g. 510R) each of which is operable to impel motion, each driving member being operable to move independently of every other one of the driving members in impelling motion; (2) coupling each of the driving members to the first structure (e.g. 120); and (3) providing power to the driving members to simultaneously drive each driving member to impel motion to the first structure away from the second structure (e.g. to pull carrier 120 upward).

In some embodiments, in operation (3) the driving members are driven with identical forces at least before the first structure separates from the second structure in at least one area.

In some embodiments, said power is pneumatic. For example, in FIG. 5A, the driving members are driven up and down with gas (supplied by pressure control system 514). Non-pneumatic power is used in some other embodiments.

Some embodiments include a debonding system for debonding a first structure from a second structure which is bonded to the first structure with a bonding layer comprising an adhesive, wherein at least one of the first and second structures comprises a semiconductor wafer, the system comprising: one or more sources of heat and/or of electromagnetic radiation (e.g. source 594), for causing the adhesive to emit gas which weakens a bond between the first and second structures; one or more sensors (e.g. one or more sensors 410) for providing data indicative of a thickness characteristic of a system comprising at least a portion of the adhesive; a plurality of driving members each of which is operable to impel motion, each driving member being operable to move independently of every other one of the driving members in impelling motion; a source of power (e.g. 514) operable to simultaneously drive the driving members when the driving members are coupled to the first structure, to cause the driving members to drive the first structure away from the second structure; a controller (e.g. 590) for causing the source of power to simultaneously drive the driving members in response to the thickness characteristic crossing a predefined threshold and/or being in a predefined range.

Some embodiments provide a controller (e.g. 590) for controlling debonding of a first structure from a second structure which is bonded to the first structure with a bonding layer comprising an adhesive, the controller being hardwired and/or programmed for: (1) causing a source of heat or electromagnetic radiation (e.g. 594) to emit heat or electromagnetic radiation; (2) during at least part of operation (1), receiving data from one or more sensors to monitor a thickness characteristic of a system comprising at least part of the bonding layer; (3) upon detecting that the thickness characteristic has crossed a predefined threshold and/or fell in a predefined range, providing power to a plurality of driving members each of which is coupled to the first structure, to drive the first structure away from the second structure with the driving members.

The embodiments described above do not limit the invention, which is defined by the appended claims.

1. A method for debonding a first structure from a second structure which is bonded to the first structure with a bonding layer comprising an adhesive, the method comprising:
(1) causing the adhesive to emit gas which weakens a bond between the first and second structures; and
(2) applying a force to separate the first and second structures from each other when the bond has been weakened;
wherein operation (1) comprises monitoring a thickness characteristic of a system comprising at least a portion of the adhesive, and operation (2) is started in response to the thickness characteristic crossing a predefined threshold and/or being in a predefined range.

2. The method of claim 1 wherein the thickness characteristic is a thickness of a system consisting of the first and second structures and the bonding layer.

3. The method of claim 2 wherein the bonding layer is a double-sided adhesive tape.

4. The method of claim 1 wherein operation (2) comprises driving the first structure with a plurality of driving members each of which is coupled to the first structure at a periphery of the first structure and/or at a periphery of the bonding layer.

5. The method of claim 4 wherein each driving member is coupled to the first structure by vacuum.

6. The method of claim 4 wherein the driving members are moveable independently from each other in impelling motion to the first structure.

7. The method of claim 4 wherein in operation (2) the driving members are driven with identical forces at least before the first structure separates from the second structure in at least one area.

8. The method of claim 1 wherein operation (1) comprises processing the adhesive with heat and/or electromagnetic radiation to cause the adhesive to emit the gas.

9. The method of claim 8 wherein operation (1) comprises processing the adhesive with the electromagnetic radiation which comprises UV radiation.

10. The method of claim 1 wherein at least one of the first and second structures comprises an integrated circuit.

11. The method of claim 1 wherein at least one of the first and second structures comprises a semiconductor wafer.

12. A method for debonding a first structure from a second structure, one of the first and second structures comprising a semiconductor wafer, the method comprising:
(1) providing a plurality of driving members each of which is operable to impel motion, each driving member being operable to move independently of every other one of the driving members in impelling motion;
(2) coupling each of the driving members to the first structure; and
(3) providing power to the driving members to simultaneously drive each driving member to impel motion to the first structure away from the second structure.

13. The method of claim 12 wherein in operation (3) the driving members are driven with identical forces at least before the first structure separates from the second structure in at least one area.

14. The method of claim 12 wherein operation (2) comprises coupling each driving member to the first structure by vacuum.

15. The method of claim 12 wherein in operation (2) each driving member is coupled to the first structure in a respective area at a periphery of the first structure, and each of said areas is about equidistant from of its two adjacent areas along the periphery.

16. The method of claim 12 wherein said power is pneumatic.

17. A debonding system for debonding a first structure from a second structure which is bonded to the first structure with a bonding layer comprising an adhesive, wherein at least one of the first and second structures comprises a semiconductor wafer, the system comprising:
one or more sources of heat and/or of electromagnetic radiation, for causing the adhesive to emit gas which weakens a bond between the first and second structures;
one or more sensors for providing data indicative of a thickness characteristic of a system comprising at least a portion of the adhesive;
a plurality of driving members each of which is operable to impel motion, each driving member being operable to move independently of every other one of the driving members in impelling motion;
a source of power operable to simultaneously drive the driving members when the driving members are coupled to the first structure, to cause the driving members to drive the first structure away from the second structure;
a controller for causing the source of power to simultaneously drive the driving members in response to the thickness characteristic crossing a predefined threshold and/or being in a predefined range.

18. A controller for controlling debonding of a first structure from a second structure which is bonded to the first structure with a bonding layer comprising an adhesive, the controller being hardwired and/or programmed for:
(1) causing a source of heat or electromagnetic radiation to emit heat or electromagnetic radiation;
(2) during at least part of operation (1), receiving data from one or more sensors to monitor a thickness characteristic of a system comprising at least part of the bonding layer;
(3) upon detecting that the thickness characteristic has crossed a predefined threshold and/or fell in a predefined range, providing power to a plurality of driving members each of which is coupled to the first structure, to drive the first structure away from the second structure with the driving members.
